(19) United States
(12) Patent Application Publication
(10) Pub. No.: US 2006/0286227 A1
(43) Pub. Date: Dec. 21, 2006

(54) Method and apparatus for processing meat, poultry and fish products

(76) Inventor: Mark Terry, Pocatello, ID (US)

Correspondence Address: FENWICK & WEST LLP, SILICON VALLEY CENTER, 801 CALIFORNIA STREET, MOUNTAIN VIEW, CA, 94041, US

(21) Appl. No.: 11/146,548

(22) Filed: Jun. 6, 2005

(51) Int. Cl. A23B 4/20

(52) U.S. Cl. 426/332

(57) ABSTRACT

Processing apparatus and method for meat, poultry and fish products include multiple successive immersions in sanitizing solutions at different successive temperatures within controlled environments including at fluid pressures different from ambient pressure to reduce resident microbial contaminants in preparation for packaging and distribution.

### RELATED CASES

The subject matter of this application is related to the subject matter of U.S. Pat. No. 6,551,641 issued on Apr. 22, 2003 to M. Terry, and is also related to the subject matter of U.S. Pat. No. 5,711,980 issued on Jan. 27, 1998 to M. Terry, and to the subject matter of U.S. Pat. No. 6,050,391 issued on Apr. 18, 2000 to M. Terry, which subjects matter are incorporated herein in their entirety by this reference to form a part hereof.

### FIELD OF THE INVENTION

This invention relates to equipment and processes for processing fresh fish or poultry or meat to retard deterioration and promote extended shelf life.

### BACKGROUND OF THE INVENTION

Fish, poultry and meat products (i.e., animal products herein) are commonly processed from catch or slaughter to market distribution in cold or frozen condition to retard the rate of decay of the product attributable to microorganisms present in or on the product. Extended shelf lives for such products commonly result from maintaining the products in frozen conditions during final processing, packaging, distribution and display. However, for such products that are not conducive to processing, packaging, distribution or display in frozen condition, icing down or otherwise refrigerating such products to cool, non-frozen condition is an alternative procedure that attains some extension of shelf life though not as extensively as in frozen condition. However, frozen product once thawed and non-frozen product commonly deteriorate rapidly out of a cold or refrigerated environment. Such deterioration is attributable to microorganisms that remain on the surface of the product as well as within the product following initial processing, and that rapidly proliferate at elevated temperatures. In contrast to fresh produce that may be harvested in the field or orchard or vineyard and that is inherently immune from deterioration at the moment of harvest, fleshy products of fish, poultry and meat are notoriously more prone to rapid deterioration from the moment of catch or slaughter.

Various types of bacteria that are commonly present, for example, on fish to be processed for distribution are believed to have many similar characteristics in their basic structure including porous cell walls comprised of mostly sugar molecules that are cross-linked by peptide bonds. This lattice-like structure provides rigidity and support to the cell to withstand the internal pressure on the cellular membrane created by the volume of the contents within the cell.

Cells are believed to have selective cellular membranes that contain integral proteins with numerous functions such as movement of objects into and out of the cells and facilitating the production of energy for the cells.

This cell membrane contains the genetic information for the cell found in the form of DNA, and contains many nutrients and structural building blocks in an aqueous, or liquid, environment. The cell wall, and specifically the bacterial membrane, are believed to be organized in a fluid mosaic model comprised of phospholipids, proteins, and other cell structures that are dynamic and constantly undergoing alterations in the number of different proteins present and in the locations of these proteins. The physical structure of the membrane includes the phosphate ends of the molecular structures that are organized facing to the exterior and interior of the cell and are hydrophilic, while the fatty acids segments of the molecular structures are hydrophobic and are sandwiched in between the phosphate groups creating selective fluidity in the membrane that selectively transfers cell-sustaining moieties into and out of the cell.

An accumulation of molecular nutrients within the boundaries of the cellular membrane creates a hypertonic environment that forms a higher concentration of molecules per volume of water than in the surrounding environment. In order for water and other nutrients to enter the cell, numerous molecule-specific passageways must exist to facilitate passage through the hydrophobic portions of the cellular membrane. These passageways are proteins called transport proteins and are imperative in creating fluidic balance between the cell and its surrounding environment. The physical structure created by the interactions of the amino acids constituting the protein regulates the entrance and exit of molecules into the cell. A passage way is formed within the protein structure that allows the passage of specific molecules the particular protein is configured to transport.

Altering the external environment to the cell to mimick conditions under which the external environment has higher molecular concentrations than the internal environment of the cell alters the flow of water and other molecules into and out of the cell and ultimately destroys the cellular membrane, resulting in death of the pathogen cell.

Aquaporins, for example, are a class of proteins that transport water molecules across membranes. The bond interactions of the amino acids create a pore in the protein. Such a pore embedded in the membrane as part of the fluid mosaic model facilitates transfer of water molecules into and out of the cell.

### SUMMARY OF THE INVENTION

In accordance with the present invention, it has been determined that alterations in pH, temperature, and pressure can destroy bond interactions which distorts this opening, allowing either more or less water to enter, depending on the desired effect. By manipulating pressure, temperature, and pH independently, or in combination with each other, the bonding properties that define the structure of the protein are disrupted, which alters the physical structure of the protein, and can render it inactive, or more appropriately, denatured.

In accordance with the present invention, fish, poultry and meat products are initially processed through a series of diverse environments including vacuum and pressure conditions applied to processing fluids at various temperatures to significantly diminish the internal and surface concentrations of pathogens. Reduced levels of residual pathogens thus achieved delay proliferation of microorganisms and the resultant decay of the product at elevated temperatures. The resultant product exhibits extended shelf life, even after freezing and thawing, and also exhibits appealing marketability for enhanced product sales with reduced losses over longer processing, distribution and retailing intervals.

Protein denaturing and cellular death of the bacteria are achieved while maintaining the integrity of the product. In one embodiment, various processing in three vessels subject the product and contaminates to variations in pH, temperature, and pressure as the product passes through each vessel.

### BRIEF DESCRIPTION OF THE DRAWINGS

FIG. 1 is a pictorial illustration of an assembly of successive environments for processing product in accordance with the present invention;

FIG. 2 is a plan view of a vessel of FIG. 1;

FIG. 3 is a plan view of the product-tumbling conveyor in the assembly of FIG. 1;

FIGS. 4 and 5 are perspective views of transfer conduits in the assembly of FIG. 1;

FIGS. 6a, 6b comprise a flow chart illustrating the processes of the present invention; and

FIGS. 7-13 are graphs illustrating results of processing according to the present invention to reduce various pathogens in comparison with results of conventional processing.

### DETAILED DESCRIPTION OF THE INVENTION

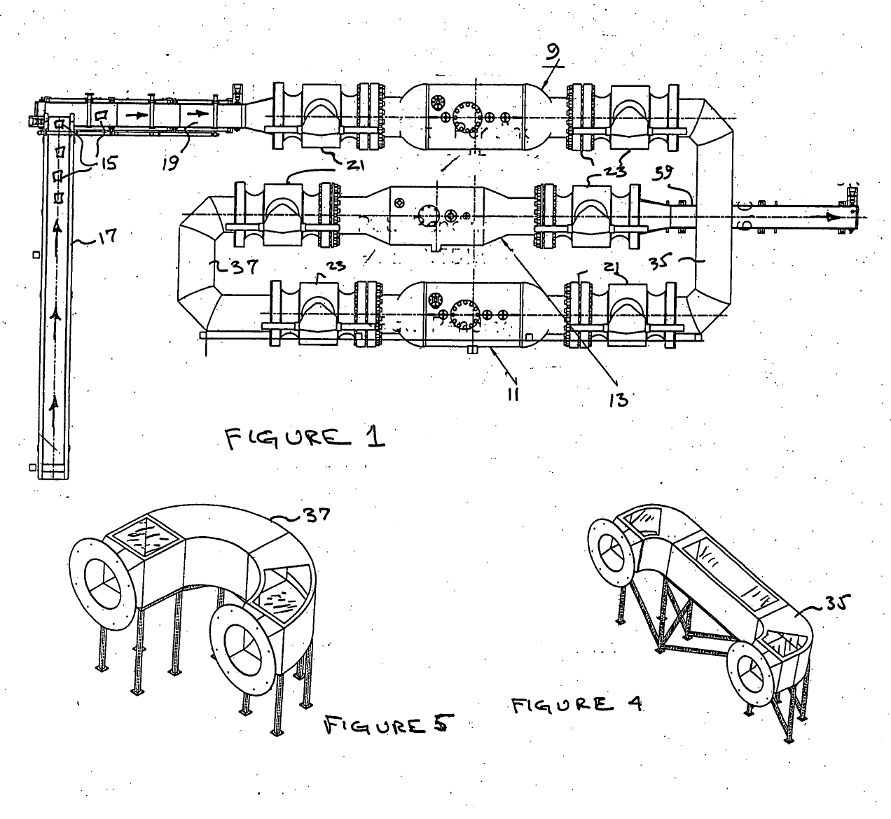

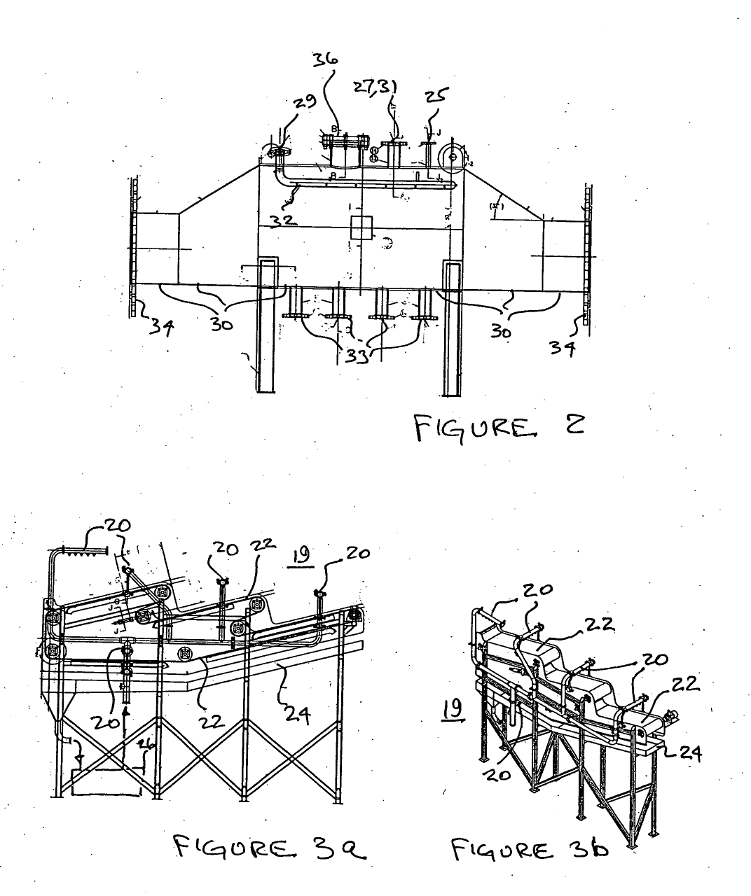

Referring now to FIG. 1 there is shown a pictorial illustration of a product processing line and process vessels 9, 11, 13 containing variable environments through which product 15 is processed according to the present invention. This succession of vessels is assembled to receive fish, poultry or meat products 15 previously cleaned, scaled, filleted, or otherwise prepared or dressed from the initial natural state following catch or slaughter of the host animal. Such preparations of the product 15 may be performed at work stations (not shown) arrayed along a length of a conveyor 17 for feeding into a tumbling conveyor 19, as described later herein with reference to FIG. 3a, 3b. The product 15 is randomly tumbled and washed along conveyor 19 in preparation for entry into the first processing vessel 9 through open inlet valve 21, with the downstream outlet valve 23 closed. Each of the pressure vessels 9, 11, 13, as illustrated in FIG. 2, is configured generally as a cylindrical chamber that includes an air vent 25 for normalizing internal vessel pressure, and a vacuum line 27 for reducing internal pressure in the associated vessel. In addition, each vessel includes a fill line 29 for supplying sanitizing fluid and a pressurizing line 31 for increasing the internal pressure within the associated vessel. And, each vessel includes one or more drain lines 33 for transferring sanitizing liquid from the associated vessel. Each vessel is arranged in fluid communication with a successive vessel through closed transfer conduits 35, 37 and inlet and outlet valves 21, 23 that may be selectively opened to transfer product 15 therethrough, and closed to establish and maintain a pressurizable environment within the respective vessels.

The valves 21, 23 may include a sliding gate or rotating ball, or the like, to selectively open or close the transfer conduits 35, 37 between vessels 9, 11, 13. Thus, product 15 may proceed along the conveyors 17, 19 and through the open valve 21 into the first processing vessel 9.

Following the loading of product 15 into the first vessel 9, the inlet valve 21 is closed and the loaded products 15 are initially immersed in an aqueous sanitizing solution, for example, a peroxygen compound (e.g., peroxyacetic acid, Octanoic acid and hydrogen peroxide and approximately 99% water) as an anti-microbial agent that is colorless, odorless and tasteless. The sanitizing solution, at a concentration of about 100 parts per million, is supplied to the vessel 9 and circulated between fill and drain lines 29, 33 through pumps, filters, and cooling equipment (not shown) at a temperature of about 32°-35° F. to effectively thermally shock the loaded product 15. During this interval, the fluid pressure is increased to a level of about 980 pounds per square inch (gage pressure). Then, the fluid pressure is reduced and vacuum is drawn down below ambient to about 2.4 pounds per square inch. Selected levels of fluid pressure and vacuum may be achieved by pumps (not shown) that connect to the vessel via pressure or vacuum connections 27, 31. The cycles of pressurization and vacuum may extend for about 55 seconds and may be repeated one or more times (typically 5 times for Gadus.Macrocephalus, or Cod) depending upon the type of product 15. This procedure is believed to apply hypo- and hyper-tonic osmotic processes to the fish, poultry or meat tissues of product 15 to alter alter the functioning of the cell walls and cell-wall proteins in a manner as previously discussed herein. This procedure is believed to eliminate contact Prokaryotic Cells via lysis prepare the product 15 for the next processing environment. The total dwell time in the initial environment within vessel 9 over the interval of the selected number of fluid pressure and vacuum cycles ensures substantial reductions in bacterial concentrations at logarithmic rates per unit time of immersion and pressure-vacuum cycles, as is commonly understood in the food processing industry. Product 15 of larger unit volumes greater than a cut size of about 10 pounds may require additional immersion time to accomplish comparable concomitant reductions in bacterial concentrations. The fluid pressure in the vessel 9 is then relieved or normalized to ambient condition through the valved air vent 25 after the initial phase of processing in vessel 9.

By this processing, the product is subjected to a low pH or high peroxygen concentration environment due to the addition of the peroxygen compound, a decreased temperature gradient, and fluctuating fluid pressure and vacuum cycles over a specified cycling period of approximately five minutes. This process performs a primary contact kill of microbes on the surface of the product. The pressurized environment creates an apparent high concentration of hydrogen ions donated by the peroxygen compound on the exterior of the cell, and this increases movement of molecules into the cell. The cell wall itself is weakened from the disruption of peptide bonds by adding oxygen donated by the peroxygen compound across the bond. By cleaving the peptide bonds that hold the crosslinkers of the sugar molecules together (that is, either the tetrapeptide in gram negative bacteria or the tetrapeptide and the pentaglycine crosslinkers in gram positive bacteria) the cell wall is severely weakened. The addition of osmotic pressure and changes in pH, altering protein structures in the membranes, act in addition to the weakened cell wall, thereby increasing fluidity of the protein transfer channels to result in bacterial cell lysis at a substantially more effective level.

Product 15 in vessel 9 is next transported from the vessel 9 to the second processing vessel 11 via transfer conduit 35 and open outlet valve 23 and open inlet valve 21, with the downstream outlet valve 23 of vessel 11 closed. The transfer conduit 35 is described later herein with reference to FIG. 4. After the quantity of product 15 is loaded into the second processing vessel 11, the inlet valve 21 is closed to confine the product 15 within the vessel 11, and a sanitizing agent such as described previously at a concentration of about 140 parts per million is introduced into and circulated within the vessel 11 between fill and drain lines 29, 33 at an elevated temperature (for example, of about 72° F. for Gadus.Macrocephalus, or Cod). The internal fluid pressure is then elevated to a pressure above ambient to about 980 psi (gage) and the processing liquid is circulated in vessel 11 in a manner as previously described herein between fill and drain lines 29, 33. Then, the internal fluid pressure in vessel 10 is reduced and vacuum is drawn down below ambient to about 2.4 pounds per square inch. Such fluid pressure and vacuum cycling may extend for about 40 seconds and may proceed one or more times (typically 5 times for Gadus.macrocephalus, or Cod), depending upon the type of product 15, at substantially the temperature of liquid in vessel 11. This intermediate processing in vessel 11 is believed to cause an expansion of the cellular matrix and an increased osmotic effect with concomitant increased rate of penetration of sanitizing solution through the Eukaryotic cellular walls and into the interior portions of the cells where the anti-microbial liquid agent can more effectively destroy pathogens within the cell matrix of the product 15. At the end of the processing interval, the internal fluid pressure in vessel 11 is normalized through the valved air vent 25 to ambient pressure, and the drain 33 is opened to release the volume of processing liquid. The downstream outlet valve 25 is opened to transfer the product 15 through the transfer conduit 37, to the third processing vessel 13. A state of expanded cellular matrix in the product 13 is thus achieved and maintained while passing through the transfer conduits 37 and open inlet valve 21 to the third vessel 13.

In the second vessel 11, the elevated temperature and fluctuating fluid pressure and vacuum cycles infuse the organic peroxygen compound into the cellular matrix of the product via expansions created in the matrix of the product itself by the push and pull effect created by the cyclic exposure to fluid pressure and vacuum to facilitate the action of the peroxygen compound on the bacterial cells. The contrasting molecule concentrations in the environment surrounding the cells and in the cells internal environment influences the movement of molecules into the cell resulting in cytoplasmic membrane disruption and protein denaturing. This step effectively destroys bacteria on the interior tissues of the product in addition to the surface kill experienced in the first vessel, while maintaining the integrity of product itself. In the second vessel the product is exposed to cycles of oscillating fluid pressure and vacuum that expand the cellular matrix of the tissues, allowing for infusion of the organic peroxygen compound on the surface and into the interior of the product. This is believed to disrupt the hypo- and hypertonic dynamics and create a push and pull effect on the cell matrix of the product. The peroxygen compound introduces oxygen, which carries a negative charge and which attracts hydrogen ions carrying a positive charge. These ions are involved in bonding interactions of the cell wall and proteins to disrupt the physical structure. To facilitate the expulsion of the infused solutions, the third vessel 13 uses highly diluted, super-chilled sanitizing solution, for example, of the type previously described, with vacuum cycles to expel the unwanted fluids from the cellular matrix of the product and to lower its total fluid volume.

In similar manner as previously described herein, product 15 is then transported via the transfer conduit 37, as described later herein with reference to FIG. 5, and open inlet value 21 to the third processing vessel 13 for loading therein, with the downstream outlet valve 23 closed. After a sufficient quantity of product is loaded into the vessel 13, the upstream inlet valve 21 is closed to confine the product 15 within the vessel 13, and sanitizing solution such as previously described herein at a concentration of about 70 parts per million is introduced into and circulated within the vessel 13 at reduced temperature of about 31-33° F. The internal fluid pressure is then reduced or ramped down through the vacuum line 27 to a level below ambient pressure of about 2.4 pounds per square inch over an interval of about 4 minutes. The vacuum level is then further reduced to about 0.000147 pounds per square inch for an interval of about 1.5 minutes, with the sanitizing solution drained from the vessel 13 through the drain lines 29, 33 in the manner as previously described herein.

This final processing in vessel 13 (prior to packaging operations) is believed to cause a contraction of the cellular matrix and an expulsion of undesirable fluids from the tissue in product 15, as well as creating a “dormancy” state of cellular respiration in preparation for final packaging. At the end of this final processing interval, the internal fluid pressure is normalized to ambient pressure via the valved air vent 25. The drain lines 33 are opened to release the volume of super chilled sanitizing solution, and the downstream outlet valve 23 is opened to release product 15 through the transfer conduit 39 in a fluid movement out of the vessel for packaging in suitable manner. A nearly dormant and contracted cellular matrix state in the product 15 is thus achieved and maintained in preparation for the packaging. The cellular matrix begins to expand to its initial state (e.g., as at the beginning of the process) from the near-dormant respiration rate that was achieved through the previous processing, and this promotes drying of the exterior of the product 15 and reduces the growth of pathogens which breed in oxygen and moisture.

Processing in this manner through vessels 9, 11, 13 sanitizes the product without altering the texture, appearance, color or flavor profile, and a form of atmosphere-modifying packaging is utilized to control gas levels and packaging that occurs within an ultra low-particulate filtered environment to eliminate cross-contamination of the sanitized product. The final product is encapsulated or otherwise packaged in a sterile packaging bag or wrapping material with a specific oxygen transmission rate, or OTR of about 30. (OTR is a measurement of how many cubic centimeters of oxygen pass through a 100 square inch portion of wrapping material during a 24 hour period at 23° C.). This step controls the concentrations of oxygen and carbon dioxide inside the final packaging so that metabolic activities, the functions necessary for the bacteria to live, are reduced to ensure that any organisms that survive the processing are not able to replicate due to lack of oxygen for metabolism. Heat accumulation in the packaging is greatly reduced because of the controlled release of gases, thereby creating a slow bacterial growth accumulation or extended growth curve. This type of packaging extends the shelf life of the product due to the inhibition of bacterial growth and lack of cross-contamination.

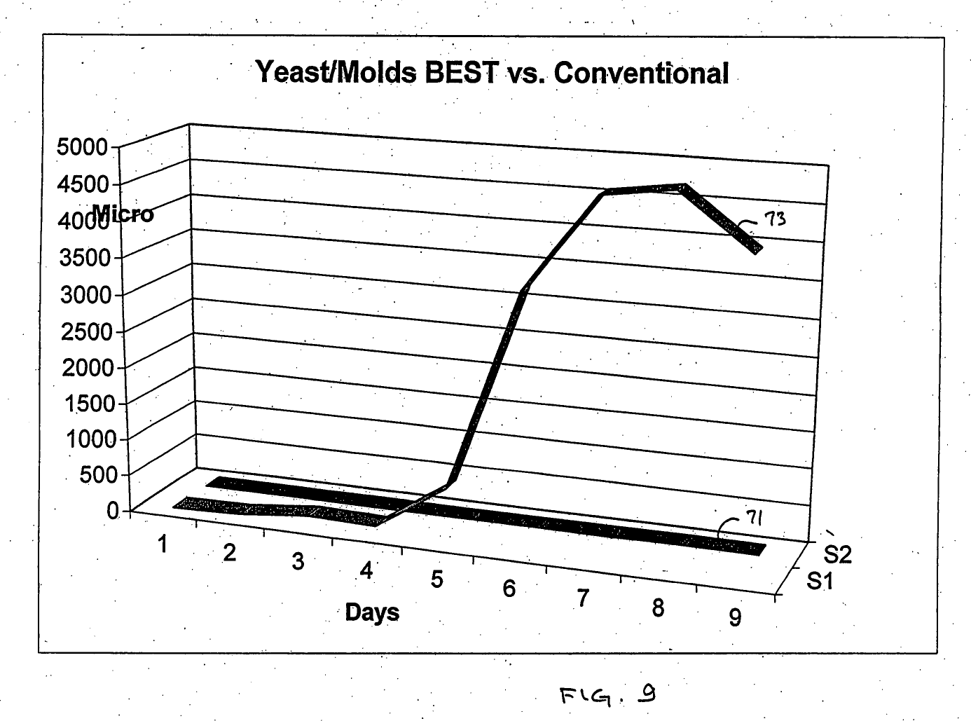

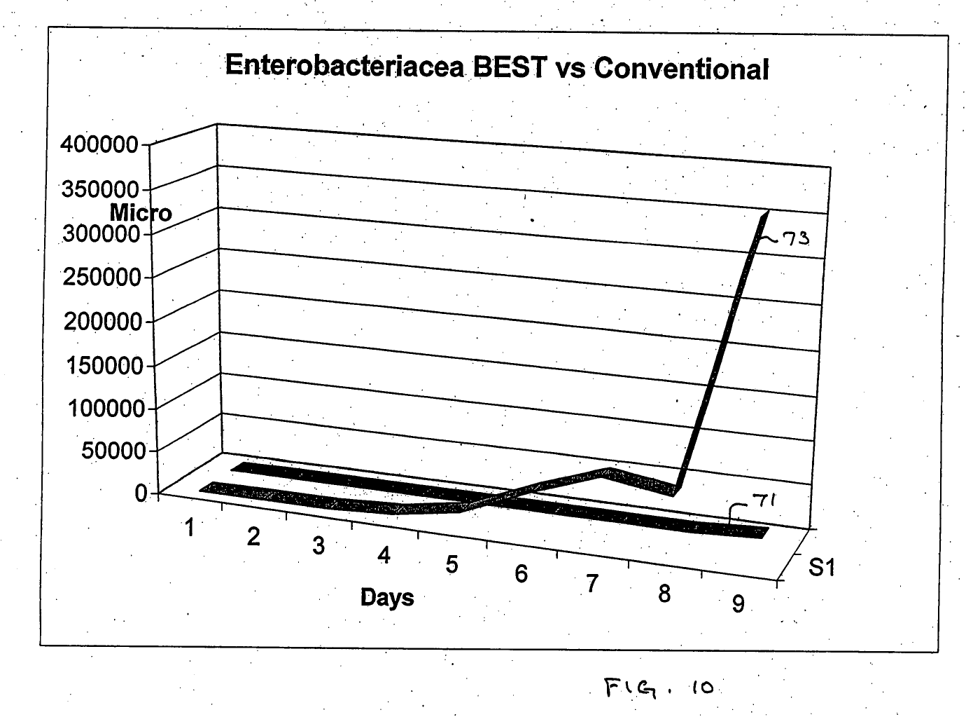

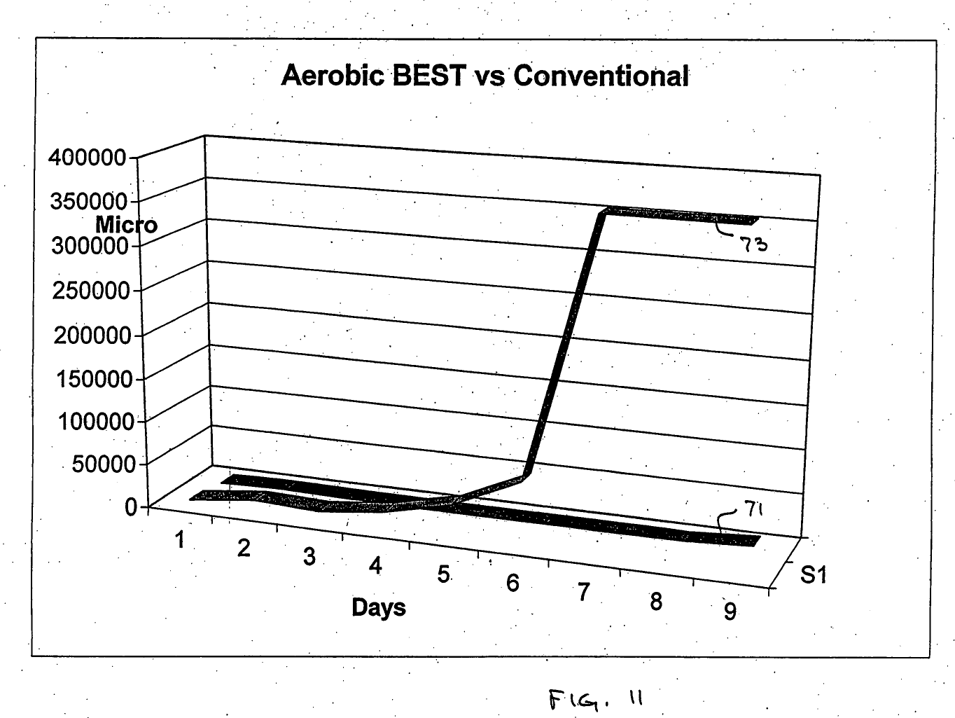

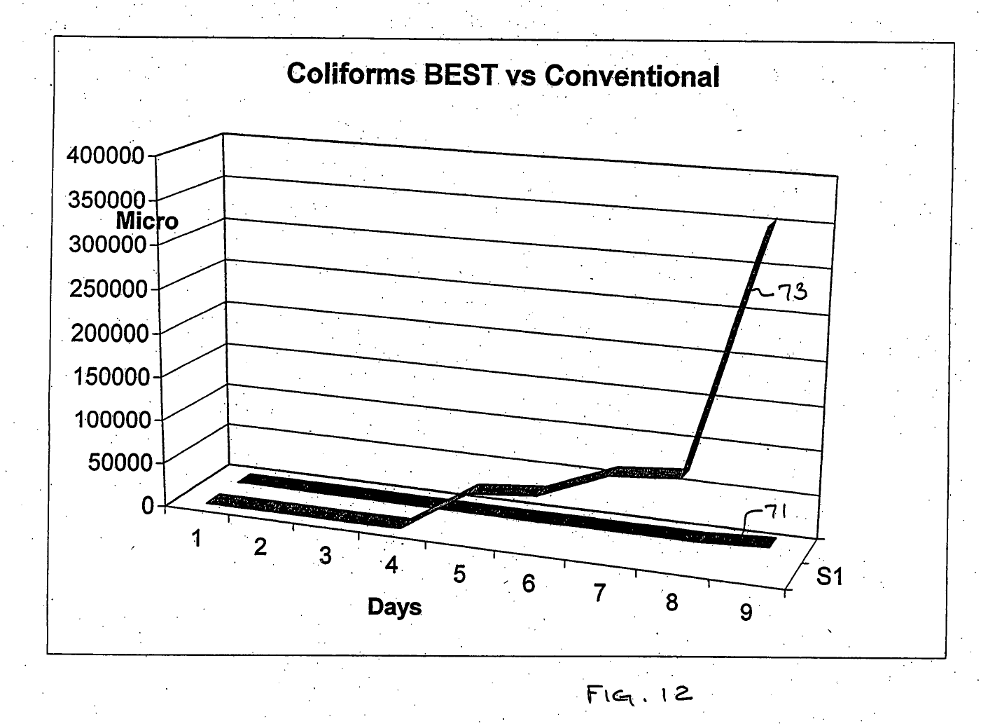

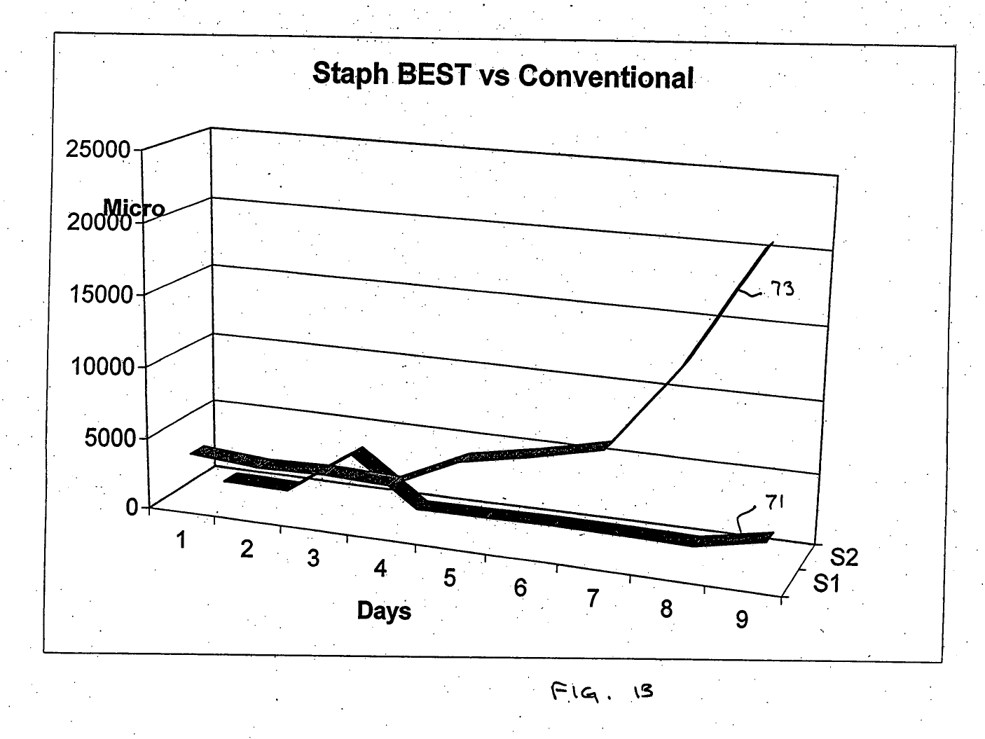

As illustrated in the graphs of FIGS. 7-13, the concentrations 71 of vanous identified bacterial pathogens in samples of Gadus.Macrocephalus fish product 15 processed according to the present invention compare favorably after 3 or 4 days with significantly higher concentrations 73 of the various bacterial pathogens in such product processed in conventional manner.

The pressure and vacuum ramp up and ramp down intervals to respective fluid pressure and vacuum levels in each of the vessels 9, 11, 13 are selected to maximally achieve reduced levels of pathogens in the type of product 15 being processed. Examples of typical processing fluid pressure and vacuum levels and temperatures and cycles and times another product is set forth in the following tables.

In Vessel 9:

| | | | Vacuum Level | Pressure/ | Vacuum/ | |
|---|---|---|---|---|---|---|
| | Pres- | Dwell | Below | Vacuum/ | Pressure | |
| | sure | Time | Ambient | Dwell | Cycles | Temp. |
| Pol- | 595 | 1:20 | 2.4 psi | 1:00 | 8 | 34° F. |
| lock | psi | | | | | |

In Vessel 11:

| | | | Vacuum Level | Pressure/ | Vacuum/ | |
|---|---|---|---|---|---|---|
| | Pres- | Dwell | Below | Vacuum/ | Pressure | |
| | sure | Time | Ambient | Dwell | Cycles | Temp. |
| Pol- | 595 | 1:20 | 2.4 psi | 1:00 | 8 | 69° F. |
| lock | psi | | | | | |

In Vessel 13:

| | First | | Second | Final | |
|---|---|---|---|---|---|
| | Vacuum | | Vacuum | Vacuum | |
| | Level Below | Dwell | Level Below | Dwell | |
| | Ambient | Time | Ambient | Time | Temp. |
| Pollock | 2.4 psi | 4:35 | .000147 psi | 1:20 | 31.6° F. |

Where desirable, product 15 emerging from the last processing vessel 13 may be quick frozen in conventional matter within a freeze-processing environment for transfer to the final packaging. Alternatively, product 15 emerging from the last processing vessel 13 may be transferred directly to the final packaging phase where frozen product is not desirable. The packaging environment may be maintained at about 33-35° F. via cooling and filtering equipment (not shown) to inhibit thawing of frozen product 15 transferred from a quick freeze environment while being wrapped and sealed or otherwise encapsulated for retail distribution under sustained freezing temperatures during transport and storage. Alternatively, product 15 transferred from vessel 13 in non-frozen but dormant state is maintained in such state during the brief interval while being wrapped and sealed or otherwise encapsulated for retail distribution under sustained near-freezing temperature and during transport and storage.

Referring now to FIG. 2 there is shown a plan view of typical vessels 9, 11, 13 of type that are assembled in the succession illustrated in FIG. 1. In one embodiment of the vessels 9, 11, 13, the main chamber is substantially cylindrical with hemispherical or conical end segments, as desired to comply with facility layout restrictions, that are disposed eccentrically or angularly with the central cylindrical segment of the vessel and with the transfer-conduits 35, 37 at each end. The eccentric alignment of vessel 9, 11, 13 and transfer conduits 35, 37 establishes common alignment along the peripheral base 30 of mating interior surfaces to promote easy transfer of product 15 into and out of the vessel. Each vessel includes filler line 29 that includes a substantially horizontal conduit 32 positioned within and along a substantial length of the vessel. The horizontal conduit 32 includes orifices located along its length oriented generally downwardly and laterally to promote mixing and agitation of contents within the vessel in response to liquid supplied thereto under pressure. This assures complete filling of the vessel with liquid and product for processing as described herein. Such filler line 29 is assembled with pumps and filters and heating or cooling equipment (not shown) for collecting, filtering, processing and supplying liquid to the vessel at pressures relative to internal pressures and at appropriate product-processing temperatures, as previously described herein.

Each vessel is also fitted with one or more drain lines 33 at the bottom of the vessel for removing liquids thereof to recycle during product processing, or to evacuate liquids from the vessel prior to transferring processed product therefrom. In addition, each vessel also includes pressure and vacuum lines 27, 31 and a pressure-release line 25 fitted to the top of the vessel for selectively pressurizing and evacuating the vessel during product processing in the manner as previously described herein. Flanges 34 attached at each end of the vessels facilitate pressure-tight attachments to mating flanges on the valves 21, 23 that are disposed intermediate each of the assembled vessels 9, 11, 13, as illustrated and described herein with reference to FIG. 1. A viewing port 36 containing a sight glass or window is fitted to each vessel near the top if so required to facilitate visualization of the agitation of product 15 and liquid within the vessel. Of course, the vessels 9, 11, 13 may be of different volumetric sizes, for example, to accommodate greater volumes of product 15 per processing cycle, or to accommodate processing of product 15 over different processing times per vessel.

In another embodiment of the present invention, one or more of the vessels 9, 11, 13 may be substantially cylindrical and mated with end sections of selected configurations to accommodate facilities where space constrictions are not present.

Referring now to FIG. 3, there is shown a side view of a tumble-style conveyor 19 that is positioned at the entrance to the first processing vessel 9 to receive unitized product 15 from conveyor 17. Specifically, this conveyor 19 and conveyors 17 and 39 may be configured similarly to a conveyor, for example, as described in U.S. Pat. No. 6,050,391 with a plurality of spray nozzles 20 disposed above and below segments of the continuous belt 22 to wash and sanitize the upper and lower surfaces thereof with sanitizing solution supplied under pressure to the connecting conduits by pumping equipment 26.

The successive stages of the elevate-and-drop configuration of the serpentine-like path of the belt 22 promotes tumbling and thorough washing of product 15 dropped from an elevated portion to a lower portion of the belt 22 along its path of travel toward the inlet to the first processing vessel 9.

Referring now to FIGS. 4 and 5, there are shown perspective views of longer 35 and shorter 37 transfer conduits that are disposed between processing vessels 9, 11 and 11, 13. In one embodiment of the shorter transfer conduit 37 as a generally semicircular conduit, an annulus-shaped conveyor system operating in folded, semi-circular configuration suffices to move product 15 from processing vessel 11 to processing vessel 13. Similarly, in the longer transfer conduit 35, such a semicircular conveyor system, or a linear conveyor system disposed between quarter-turn conveyor systems may suffice to move product 15 from processing vessel 9 to processing vessel 11. Alternatively, adequate elevation of vessel 11 above vessel 13, and elevation of vessel 9 above vessel 11 may promote gravity transfer of product 15 between vessels, aided by a flow of sanitizing solution exiting from a preceding vessel.

Equipment for filtration, cooling or heating and pumping of the processing liquids, as well as for pressurizing vessels and refurbishing processing liquids may all be housed remotely from the processing of product 15 through the assembly of vessels 9, 11, 13 and may be piped and ducted thereto in order to preserve sanitary conditions and to avoid contaminants from machine-oriented sources.

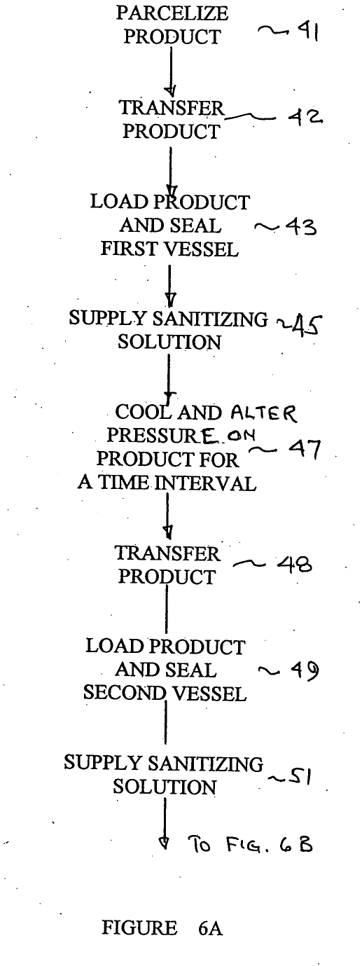

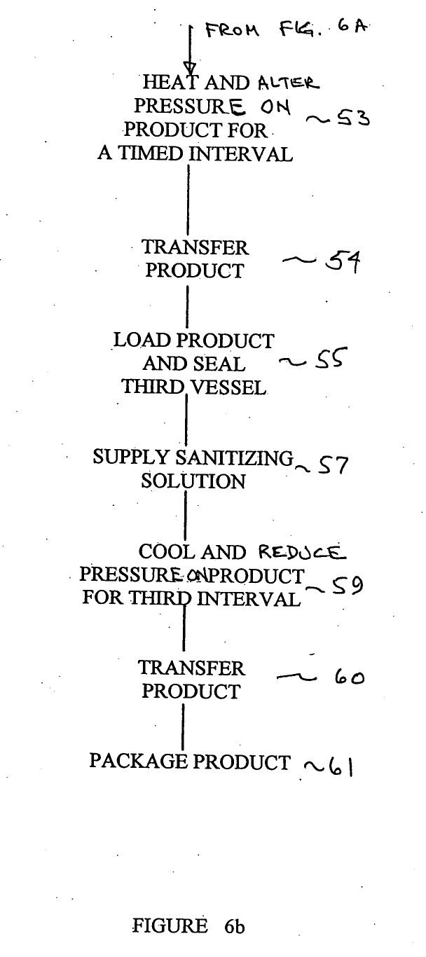

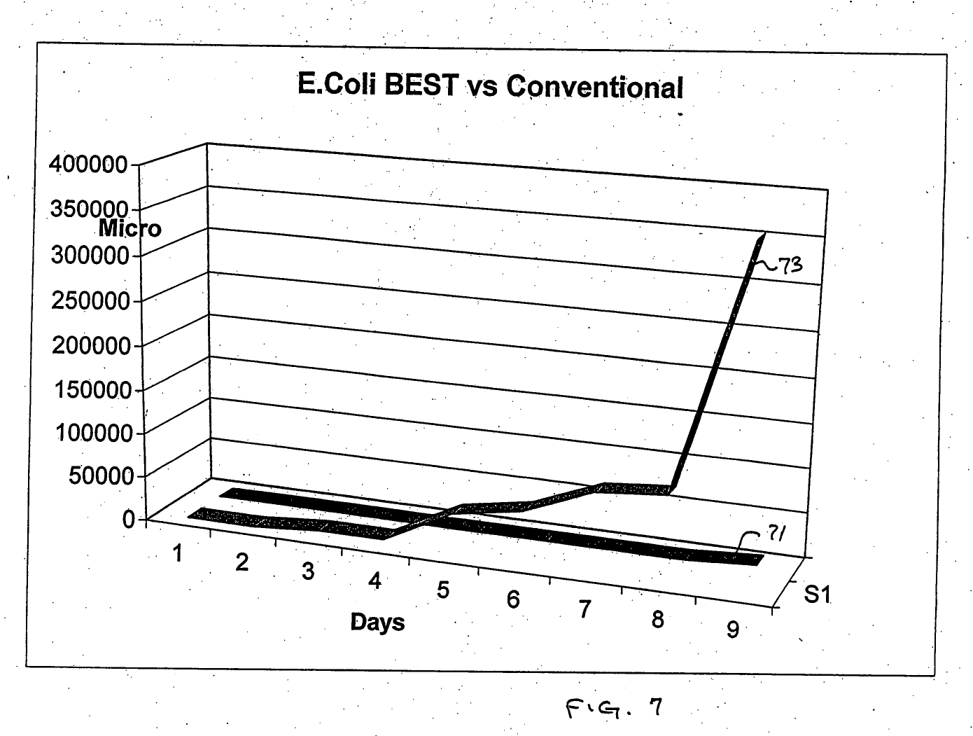

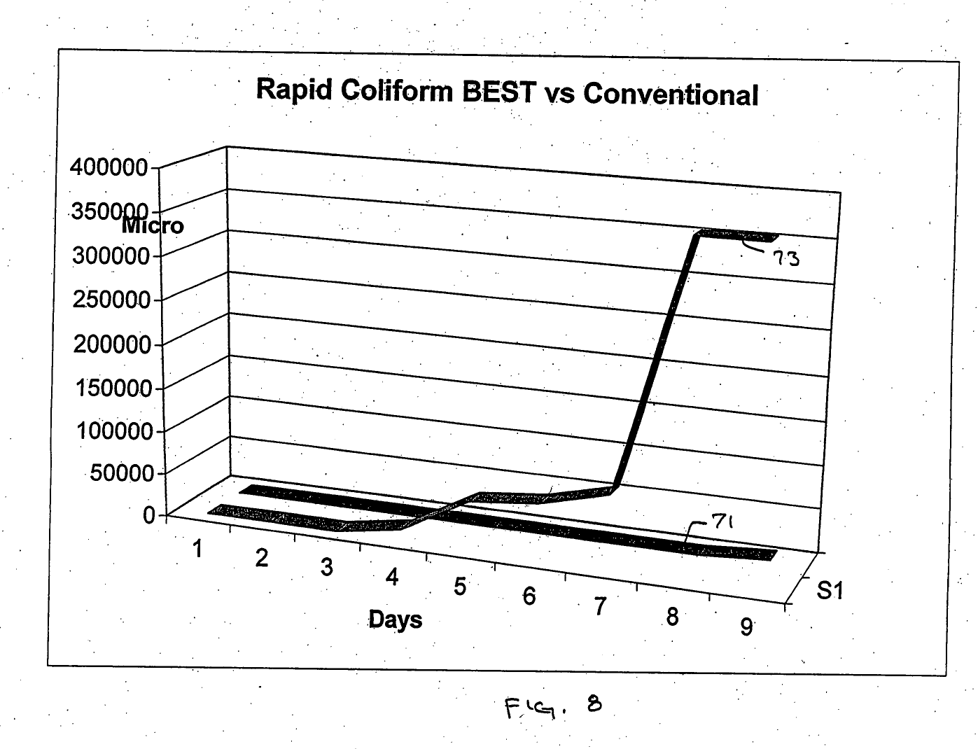

Referring now to the flow chart of FIGS. 6a, 6b, the processing of a product 15 starts with parcelizing 41 unit volumes of the product, for example, as fillets, steaks or poultry parts that are then transported 42 to and confined 43 within the first processing vessel 9. Sanitizing solution of a type as previously described herein is then supplied 45 to and circulated within the first processing vessel 9 at a temperature near freezing for a first processing interval 47 during which internal fluid pressure is varied above and below ambient pressure one or more times, as previously described herein.

At the conclusion of the first processing interval, the product 15 is transferred 48 through the valve in the transfer conduit 35 to the second processing vessel 11 for confinement 49 therein between closed valves. Sanitizing solution of a type as previously described herein is then supplied 51 to and circulated within the second processing vessel 11 at a temperature of about 72° F. for a second processing interval 53 during which internal fluid pressure is varied above and below ambient pressure one or more times, as previously described herein.

At the conclusion of the second processing interval, the product 15 is transferred 54 through the valve in the transfer conduit 37 to the third processing vessel 13 for confinement 55 therein between closed valves. Sanitizing solution of a type as previous described herein is then supplied 57 to and circulated within the third processing vessel at a temperature near freezing for a third processing interval 59 during which internal pressures are reduced to vacuum levels below ambient pressure in manner as previously described herein.

At the conclusion of the third processing interval, the product 15 is transferred 60 to a packaging environment 61 for sealed wrapping or other encapsulation in either quick frozen or non-frozen condition suitable, for example, for retail distribution.

Therefore, animal products processed in accordance with the present invention exhibit a greatly reduced pathogen count with concomitant slower growth of bacteria and retardation of the KREBS cycle. The apparatus and processes of the present invention thus greatly reduce pathogenic contaminants that contribute to the deterioration of meat, poultry and fish products prepared for retail distribution, and thereby significantly increase retail shelf life of such products.

What is claimed is:

1. A method for processing animal products, comprising:
immersing the product in a sanitizing solution at a temperature in the range of approximately 32°-34° F. and at selected pressures varied above and below ambient pressure during a first time interval;
after the first time interval, immersing the product in a sanitizing solution at a temperature in the range of approximately 69°-72° F. and at selected pressures above and below ambient pressure during a second time interval;
after the second time interval, immersing the product in a sanitizing solution at approximately 32° F. and at a selected pressure below ambient for a third time interval; and
after the third time interval, preparing the product for distribution.

2. The method according to claim 1 in which the selected pressures during at least the first and second intervals are varied above and below ambient pressure a plurality of times.

3. The method according to claim 1 in which the pressure during the third interval is below ambient pressure.

4. The method according to claim 1 in which the first time interval is in the range of approximately 55 seconds to approximately 19 minutes.

5. The method according to claim 1 in which the second time interval is in the range of approximately 40 seconds to approximately 19 minutes.

6. The method according to claim 1 in which the third time interval is in the range of approximately 5 to 6 minutes.

7. The method according to claim 1 in which the sanitizing solution is circulated around the product during at least one of the first, second and third time intervals.

8. The method according to claim 1 in which the selected pressures during the first and second time intervals are above ambient pressure in the range of about 595 to about 980 pounds per square inch.

9. The method according to claim 1 in which vacuum levels during the first and second time intervals are in the range below ambient to about 2.4 pounds per square inch.

10. The method according to claim 1 in which a cycle of selected pressures above and below ambient pressure attained during the first time interval occur over a time interval of about 55 seconds in Gadus.Macrocephalus, or Cod.

11. The method according to claim 1 in which a cycle of selected pressures above and below ambient pressure attained during the second time interval occurs over a time interval of about 40 seconds in Gadus.Macrocephalus, or Cod.

12. The method according to claim 1 in which a cycle of selected pressures below ambient pressure during the third time interval occurs over a time interval of about 5.5 minutes in Gadus.Macrocephalus, or Cod.

13. Apparatus for processing animal products, comprising:
means for immersing the product in a sanitizing solution at a temperature in the range of approximately 32°-34° F. and at pressures above and below ambient pressure during a first processing interval;
means operable after the first processing interval for immersing the product in a sanitizing solution at a temperature in the range of approximately 69°-72° F. and at pressures above and below ambient pressure during a second processing interval; and
means operable after the second processing interval for immersing the product in a sanitizing solution at a temperature within the range of approximately 31°-33° F. and at pressure below ambient pressure during a third processing interval to prepare the product for packaging.

14. Apparatus according to claim 13 including means for isolating the product from environmental conditions during transfer of product between processing intervals.

15. Apparatus according to claim 13 including valve means associated with each of the means for immersing the product and operable in open and closed conditions for selectively transferring product therethrough in open condition between adjacent ones of the means for immersing the product, and for confining product in a means for immersing product during operation of said valve means in closed condition.

16. Apparatus for processing animal products, comprising:
a vessel having egress and ingress ports for transferring products therethough;
a valve attached at each of the ingress and egress ports of a vessel and operable in open and closed conditions for passing product therethough in open condition and for confining product in the vessel in closed condition; and
a plurality of connections to the vessel for supplying fluids to and removing fluids from the vessel.

17. Apparatus according to claim 16 in which the vessel is substantially cylindrical over a portion of the length thereof; and
a connection to the vessel for supplying fluid to the vessel includes an internal segment that extends along a portion of the length of the vessel, and that includes a plurality of orifices therein spaced along the length thereof.

18. Apparatus according to claim 17 in which the internal segment is disposed substantially horizontally in an upper interior region of the vessel oriented substantially horizontally between ingress and egress ports.

19. Apparatus according to claim 16 comprising:
a view port connected to the vessel near an upper portion thereof intermediate the ingress and egress ports for visualizing the interior of the vessel.

20. Apparatus according to claim 16 in which the ingress and egress ports connect to the vessel in eccentric orientation with substantially aligned lower-most interior surfaces of the vessel and egress port.

21. Apparatus according to claim 17 in which at least one of the plurality of orifices is oriented in a direction laterally skewed from vertical.

22. A method for processing edible animal products, comprising the steps for:
a) forming unit volumes of the animal product;
b) chilling a unit volume during exposure to liquid at elevated pressure above ambient;
c) chilling the unit volume during exposure to liquid at reduced pressure below ambient;
d) warming the unit volume during exposure to liquid at elevated pressure;
e) warming the unit volume during exposure to liquid at reduced pressure below ambient; and
f) chilling the unit volume during exposure to fluid at reduced pressure below ambient.

23. The method according to claim 22 in which steps b) and c) are repeated a plural number of times.

24. The method according to claim 22 in which steps d) and e) are repeated a plural number of times.

25. The method according to claim 22 in which at least a portion of step f) is performed in air at reduced pressure below ambient.

26. The method according to claim 22 in which steps b) and c) are performed at temperatures near freezing.

27. The method according to claim 22 in which the steps d) and e) are performed at temperatures in the range of about 69°-72° F.

28. The method according to claim 25 in which step f) is performed at temperatures near freezing.

29. The method according to claim 22 in which step b) is performed at pressures in the range of about 595-980 pounds per square inch.

30. The method according to claim 22 in which step d) is performed at pressures in the range of about 595-980 pounds per square inch.

31. The method according to claim 22 in which step c) is performed at pressure of about 2.4 pounds per square inch.

32. The method according to claim 22 in which step e) is performed at pressure of about 2.4 pounds per square inch.

33. The method according to claim 22 in which step f) is performed at reduced pressures in the range of about 2.4-0.000147 pounds per square inch.

34. The method according to claim 22 in which the unit volume is isolated from ambient air in transitions between steps b), c) and steps d), e) and between steps d), e) and step f).

35. The method according to claim 4 in which the first time interval is approximately 4.5 minutes at a temperature of approximately 32° F. at pressures between about 980 and about 2.4 pounds per square inch, for cod fish.

36. The method according to claim 5 in which the second time interval is approximately 3.3 minutes at a temperature of approximately 72° F. at pressures between about 980 and about 2.4 pounds per square inch, for cod fish.

37. The method according to claim 6 in which the third time interval is approximately 5.5 minutes at a temperature of approximately 32° F. at pressures between about 2.4 and about 0.000147 pounds per square inch, for cod fish.

38. The method according to claim 1 in which the step of preparing includes:
encapsulating the product for a selected oxygen transfer rate in ambient air of approximately 30 cc of oxygen per 24 hour period.

39. The method according to claim 38 in which encapsulating includes sealing the product within wrapping material exhibiting the selected oxygen transfer rate.

40. The method according to claim 1 in which the liquid includes an effective quantity of sanitizing solution.

41. The method according to claim 40 in which the sanitizing solution includes a peroxygen component.
